(19) United States
(12) Patent Application Publication
(10) Pub. No.: US 2007/0076265 A1
(43) Pub. Date: Apr. 5, 2007

(54) Method of bit depth reduction for an apparatus

(75) Inventors: William E. Gardner, Louisville, KY (US); Du-Yong Ng, Lexington, KY (US); John Pospisil, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/242,487

(22) Filed: Oct. 3, 2005

(51) Int. Cl. H04N 1/04

(52) U.S. Cl. 358/474; 358/1.9

(57) ABSTRACT

A method of bit depth reduction for an apparatus includes establishing a human visual response versus relative luminance, the human visual response being defined by 2^{M} levels; determining a scanner response versus the relative luminance for at least one channel of scanner data, the scanner response being represented by N-bit per channel data, wherein N is greater than M; relating the human visual response to the scanner response; and quantizing the N-bit per channel data to M-bit per channel data according to the human visual response.

### BACKGROUND OF THE INVENTION

1. Field of the Invention

The present invention relates to imaging, and, more particularly, to a method of bit depth reduction for an apparatus, such as for example, a scanner.

2. Description of the Related Art

Many scanners produce raw digital data with bit depth higher than 8-bit data per channel. Most digital image reproduction systems such as monitors only handle 8-bit data per channel. The high bit depth raw data needs to be quantized to a lower number of bits per channel so that the data can be processed and rendered using these systems. One such method for bit depth reduction involves data truncation. Indiscriminant data truncation without regard to the location of the data on the luminance scale may significantly reduce the ability to discriminate gray shades and adversely impact perceived image quality.

### SUMMARY OF THE INVENTION

The invention, in one exemplary embodiment, is directed to a method of bit depth reduction for an apparatus. The method includes establishing a human visual response versus relative luminance, the human visual response being defined by 2^{M} levels; determining a scanner response versus the relative luminance for atleast one channel of scanner data, the scanner response being represented by N-bit per channel data, wherein N is greater than M; relating the human visual response to the scanner response; and quantizing the N-bit per channel data to M-bit per channel data according to the human visual response.

The invention, in another exemplary embodiment, is directed to an imaging system. The imaging system includes a scanner, and a processor communicatively coupled to the scanner. The processor executes program instruction to perform bit depth reduction by the acts of: establishing a human visual response versus relative luminance, the human visual response being defined by 2^{M} levels; determining a scanner response versus the relative luminance for at least one channel of scanner data, the scanner response being represented by N-bit per channel data, wherein N is greater than M; relating the human visual response to the scanner response; and quantizing the N-bit per channel data to M-bit per channel data according to the human visual response.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system that employs an imaging apparatus in accordance with the present invention.

FIG. 2 is a diagrammatic depiction of a color converter accessing a color conversion lookup table.

FIG. 3 is a diagrammatic depiction of an embodiment of the present invention wherein a bit depth reduction device is provided upstream of the color converter of FIG. 2.

FIG. 4 is a flowchart of a method according to an embodiment of the present invention.

FIG. 5 is a graph that illustrates the results of measurements of the human visual system response to luminance.

FIG. 6A is a graph that shows the N-bit red (R) channel response to the scanning of each of three gray targets.

FIG. 6B is a graph that shows the N-bit green (G) channel response to the scanning of each of the three gray targets.

FIG. 6C is a graph that shows the N-bit blue (B) channel response to the scanning of each of the three gray targets.

FIG. 7 graphically illustrates how each of the N-bit scanner R, G and B channels, i.e., y-axes for R_{scanner}, G_{scanner} and B_{scanner} of FIGS. 6A, 6B and 6C, is partitioned into M-bit levels.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

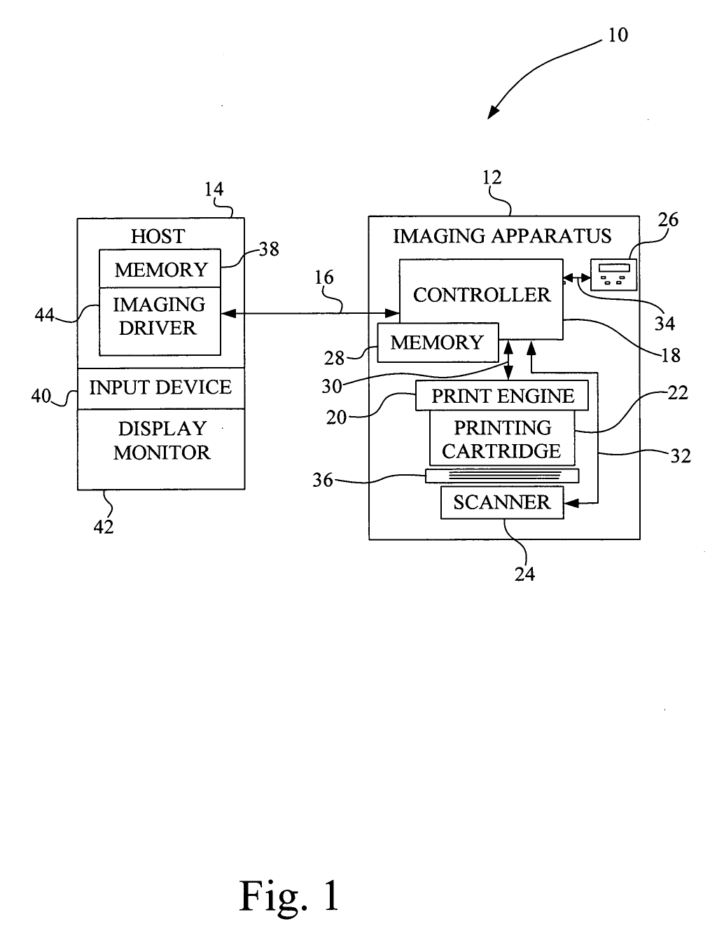

Referring now to the drawings, and particularly to FIG. 1, there is shown a diagrammatic depiction of an imaging system 10 embodying the present invention. Imaging system 10 includes an imaging apparatus 12 and a host 14. Imaging apparatus 12 communicates with host 14 via a communications link 16.

As used herein, the term “communications link” generally refers to structure that facilitates electronic communication between two components, and may operate using wired or wireless technology. Accordingly, communications link 16 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

Imaging apparatus 12 may be, for example, an ink jet printer and/or copier, or an electrophotographic printer and/or copier that is used in conjunction with a scanner, or an all-in-one (AIO) unit that includes a printer, a scanner, and possibly a fax unit. In the present embodiment, imaging apparatus 12 is an AIO unit, and includes a controller 18, a print engine 20, a printing cartridge 22, a scanner 24, and a user interface 26.

Controller 18 includes a processor unit and associated memory 28, and may be formed as one or more Application Specific Integrated Circuits (ASIC). Controller 18 may be a printer controller, a scanner controller, or may be a combined printer and scanner controller. Although controller 18 is depicted in imaging apparatus 12, alternatively, it is contemplated that all or a portion of controller 18 may reside in host 14. Controller 18 is communicatively coupled to print engine 20 via a communications link 30, to scanner 24 via a communications link 32, and to user interface 26 via a communications link 34. Controller 18 serves to process print data and to operate print engine 20 during printing, and serves to operate scanner 24.

In the context of the examples for imaging apparatus 12 given above, print engine 20 may be, for example, an ink jet print engine or a color electrophotographic print engine. Print engine 20 is configured to mount printing cartridge 22 and to print on a substrate 36 using printing cartridge 22. Substrate 36 is a print medium, and may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates printing cartridge 22 to eject ink droplets onto substrate 36 in order to reproduce text or images, etc. As an electrophotographic print engine, print engine 20 causes printing cartridge 22 to deposit toner onto substrate 36, which is then fused to substrate 36 by a fuser (not shown).

Host 14 may be, for example, a personal computer, including memory 38, an input device 40, such as a keyboard, and a display monitor 42. Host 14 further includes a processor, input/output (I/O) interfaces, memory, such as RAM, ROM, NVRAM, and at least one mass data storage device, such as a hard drive, a CD-ROM and/or a DVD unit.

During operation, host 14 includes in its memory a software program including program instructions that function as an imaging driver 44, e.g., printer/scanner driver software, for imaging apparatus 12. Imaging driver 44 is in communication with controller 18 of imaging apparatus 12 via communications link 16. Imaging driver 44 facilitates communication between imaging apparatus 12 and host 14, and may provide formatted print data to imaging apparatus 12, and more particularly, to print engine 20. Although imaging driver 44 is disclosed as residing in memory 38 of host 14, it is contemplated that, alternatively, all or a portion of imaging driver 44 may be located in controller 18 of imaging apparatus 12.

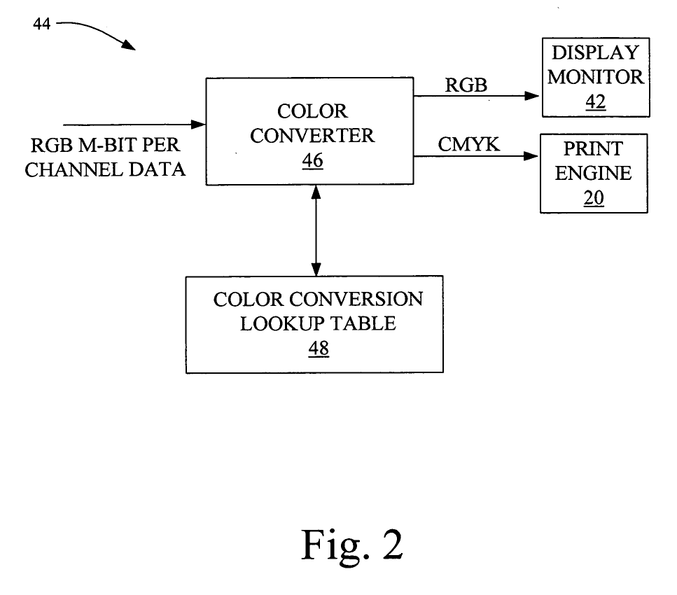

Referring now to FIG. 2, imaging driver 44 includes a color converter 46. Color converter 46 converts color signals from a first color space to a second color space. For example, first color space may be RGB color space providing RGB M-bit per channel data and the second color space may be CMYK (cyan, magenta, yellow, and black) color space that outputs CMYK output data for print engine 20. The second color space may also be an RGB color space, for example, if the desired output of imaging apparatus 12 is a scan-to-file replication of an image that might be displayed on display monitor 42. Although color converter 46 is described herein as residing in imaging driver 44, as an example, those skilled in the art will recognize that color converter 46 may be in the form of firmware, hardware or software, and may reside in either imaging driver 44 or controller 18. Alternatively, some portions of color converter 46 may reside in imaging driver 44, while other portions reside in controller 18.

Color converter 46 is coupled to a color conversion lookup table 48. Color converter 46 uses color conversion lookup table 48 in converting color signals from the first color space, e.g., RGB M-bit per channel data, to output color data in the second color space. Color conversion lookup table 48 is a multidimensional lookup table having at least three dimensions, and includes RGB input values and CMYK or RGB output values, wherein each CMYK or RGB output value corresponds to an RGB input value. Color conversion lookup table 48 may also be in the form of groups of polynomial functions capable of providing the same multidimensional output as if in the form of a lookup table.

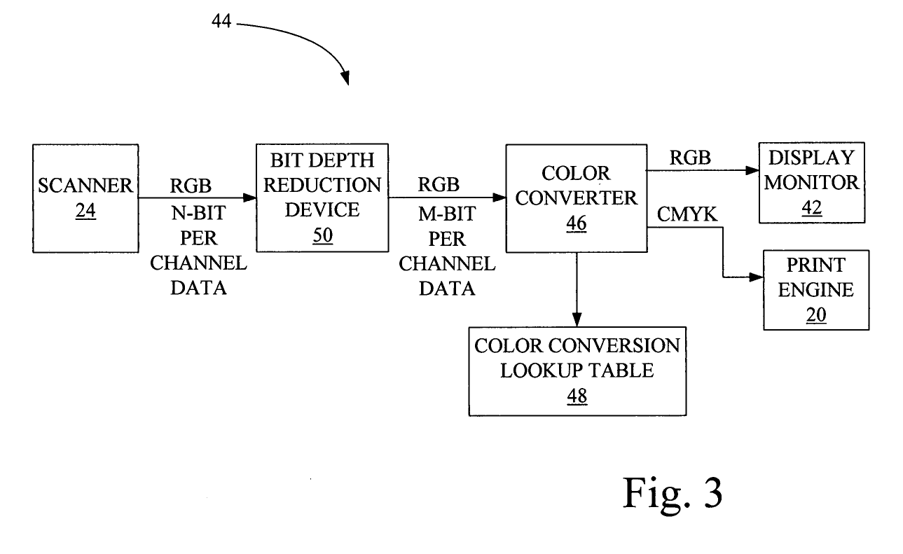

FIG. 3 shows a block diagram showing an embodiment, wherein scanner 24 provides RGB N-bit per channel data, e.g., RGB 12-bit per channel data, which is not directly compatible with the RGB M-bit per channel input format, e.g., RGB 8-bit per channel input format, accommodated by color converter 46. As such, imaging driver 44 includes a bit depth reduction device 50 that translates the raw RGB N-bit per channel data received from scanner 24 into RGB M-bit per channel data compatible with color converter 46. In this example, and the examples that follow, it is assumed that N is greater than M. It is contemplated that bit depth reduction device 50 may be implemented as software, firmware, or hardware, in one or more of imaging driver 44, controller 18 or host 14. In one embodiment, for example, bit depth reduction device 50 is implemented as a lookup table (LUT).

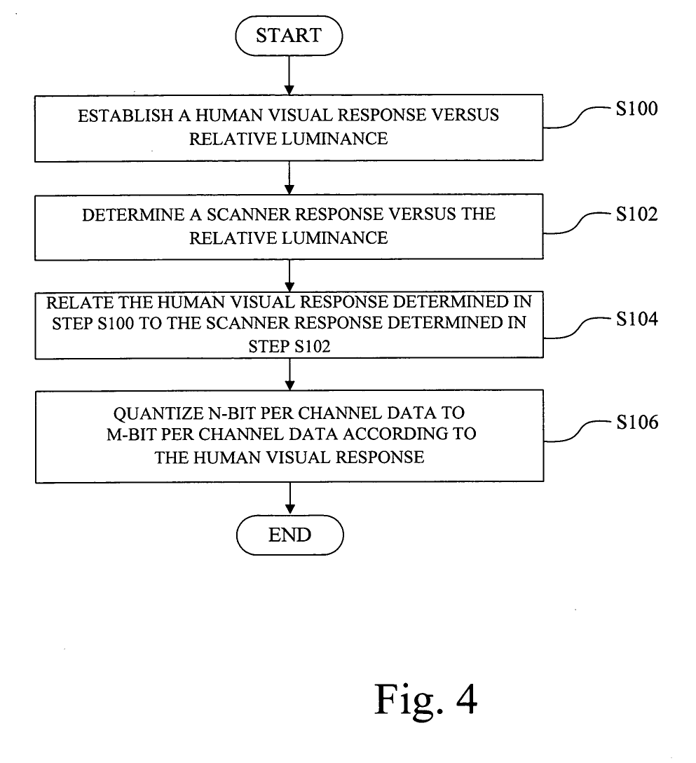

FIG. 4 is a flowchart of a method of bit depth reduction according to an embodiment of the present invention. The method may be implemented, for example, by program instructions executed by the processor of controller 18 of imaging apparatus 12 and/or the processor of host 14, and which may be a part of imaging driver 44.

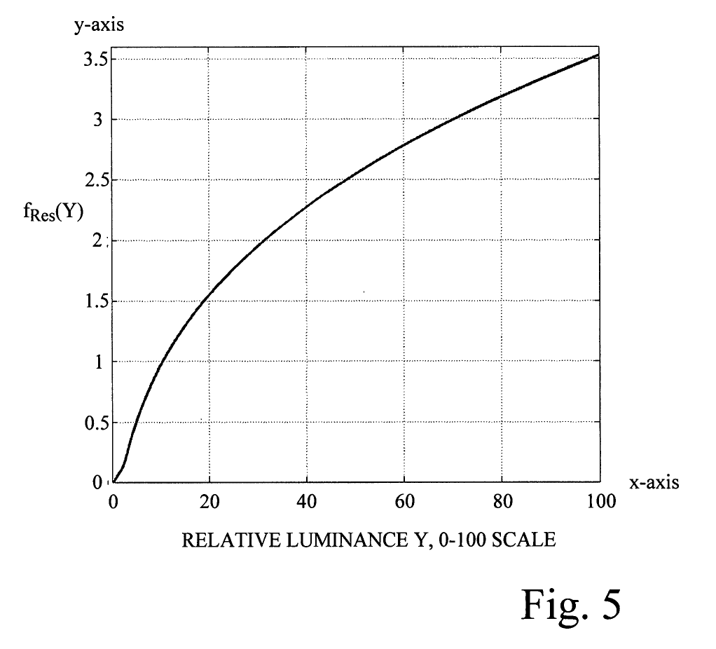

At step S100, a human visual response versus relative luminance is established. In the graph shown in FIG. 5, the human visual response (y-axis) will be defined by 2^{M} levels, which in turn can be represented by M-bit data. For example, if M=8, then the human visual response is divided into 256 digital levels, represented digitally as 0000,0000 to 1111,1111 binary (i.e., 0 to 255, decimal). Relative luminance is on a scale of 0 to 100 on the x-axis.

The graph of FIG. 5 illustrates the results of the measurement of the human visual system response to luminance. To study human visual sensitivity, a psychophysical experiment was designed to measure the average difference threshold DL, wherein DL is the amount of physical quantity that a subject needs to distinguish the difference between two stimuli, of a number of human subjects as a function of luminance Y. A calibrated LCD monitor with white point set to D65 was used to display gray patches (stimuli) with known luminance values. H equally spaced points between 0 and 2^{M}−1 along the neutral gray axis were selected. The average DL of the human subjects about each of the H points was obtained. The DL function ƒ_{Res}(Y) for the entire neutral gray axis was then obtained by linearly interpolating the H points. A continuous function that best fits the data can also be used instead. The average response ofthe subjects ƒ_{Res}(Y) is defined as:

$${f}_{Re s} ( Y ) = {\int }_{0}^{Y} {f}_{DL} ( l ) ⅆ l . \qquad Equation ( 1 )$$

The result is illustrated in the graph of FIG. 5.

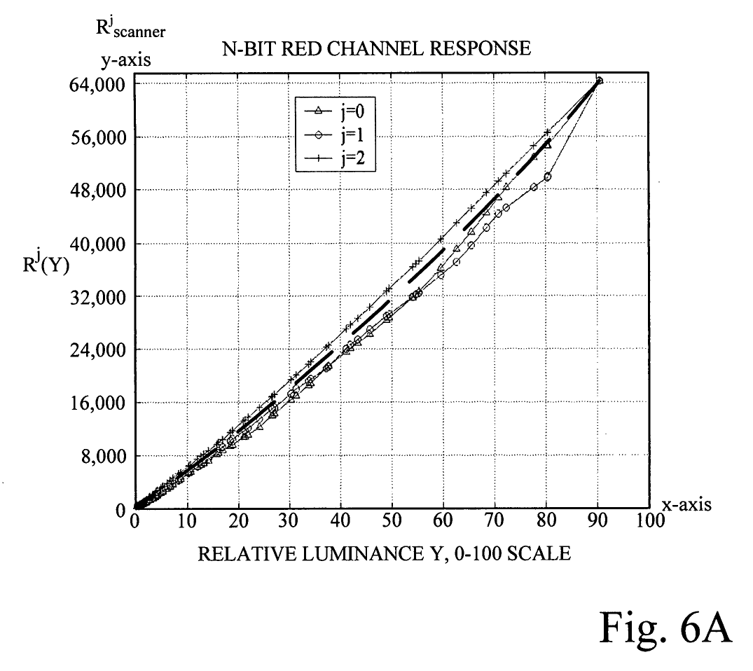

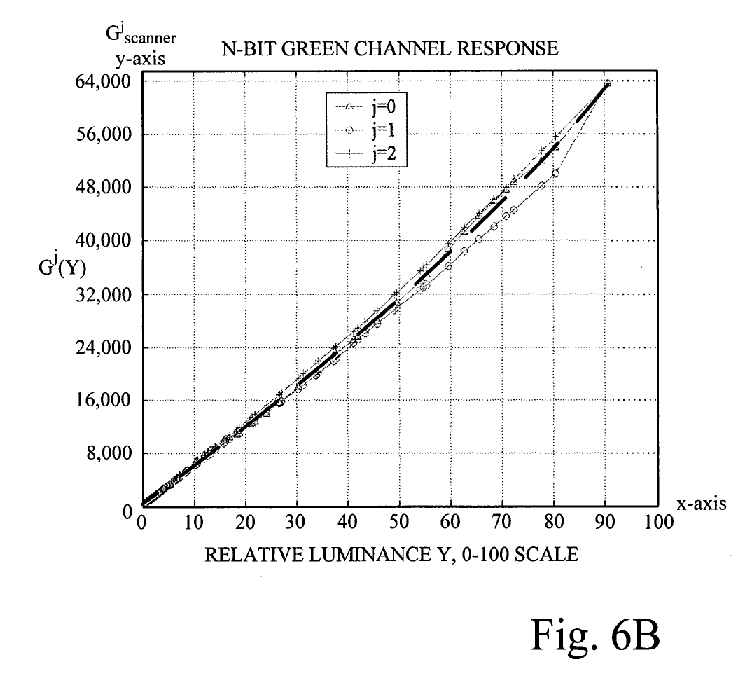

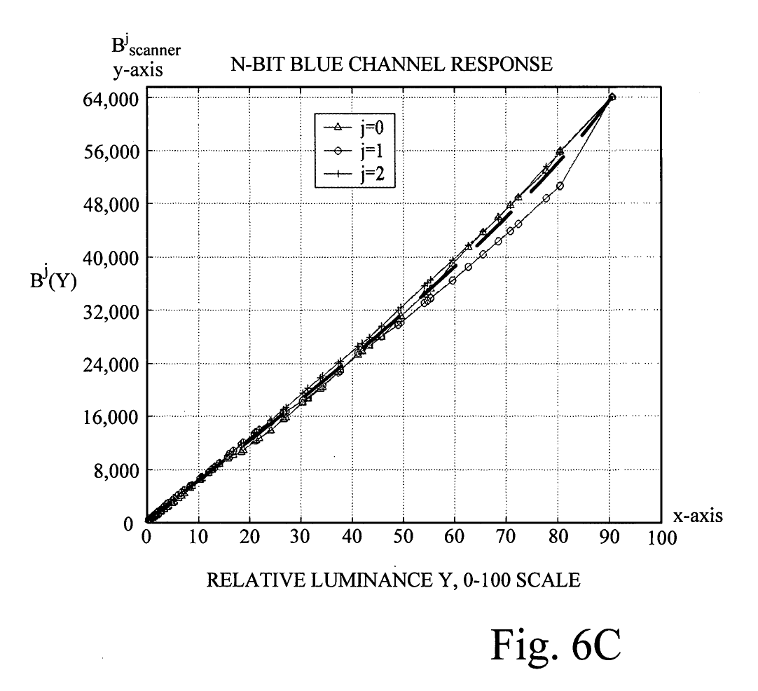

At step S102, a scanner response versus the relative luminance is determined, for example, for each channel of scanner data received from scanner 24, as illustrated in the graphs of FIGS. 6A, 6B and 6C. For example, as shown in the graphs of FIGS. 6A, 6B and 6C, each channel of scanner 24 has a scanner response (y-axis) represented by N-bit per channel data. Relative luminance (x-axis) is on a scale of 0 to 100. In order to have a need to perform bit depth reduction, it is assumed that N is an integer greater than M. For example, in an example where M=8, then N>8. In one scanner suitable for use as scanner 24, for example, N=16, and is represented by 65,536 digital levels, represented digitally as 0000,0000,0000,0000 to 1111,1111,1111,1111 (i.e., 0 to 65,535 decimal).

For illustration purposes, three sets of standard gray targets (K=3) were used in the determination, and the corresponding response functions are shown in the graphs of FIGS. 6A, 6B and 6C. FIG. 6A is a graph that shows the N-bit red (R) channel response to the scanning of each of the K=3 gray targets, identified as j1, j2, and j3. FIG. 6B is a graph that shows the N-bit green (G) channel response to the scanning of each of the three gray targets, identified as j1, j2, and j3. FIG. 6C is a graph that shows the N-bit blue (B) channel response to the scanning of each of the three gray targets, identified as j1, j2, and j3.

More particularly, referring to FIGS. 6A, 6B and 6C, the luminance values Y of the K sets of standard gray targets, i.e., hardcopy targets, are measured using a spectrophotometer. Then, these targets are scanned using the scanner of interest, e.g., scanner 24, to obtain the corresponding N-bit per channel data, i.e., the raw data, for the K gray targets. In this example, K=3, but those skilled in the art will recognize that more or less standard gray targets may be used. The scanner response of scanner 24 to each set of gray targets as a function of luminance Y can be obtained by interpolating the measured data for each channel. For example, let R^{j}_{scunner}(Y) be the scanner red channel response to the j^{th} set of gray targets as a function of luminance Y where j ∈{0, . . . K−1}. The responses for the green and blue channels denoted as G^{j}_{scanner}(Y) and B^{j}_{scanner}(Y) are obtained similarly.

At step S104, the human visual response determined in step S100 is related to the scanner response determined in step S102. As shown in each of the graphs of FIGS. 6A, 6B, and 6C, a dark dashed line is used to represent a monotonic response for each of the red, green and blue channels, respectively. The respective monotonic response for each of the red, green and blue channels is a continuous function, and is further discussed below.

Thus, the human visual response illustrated in FIG. 5 then may be related to the monotonic response for each of the red, green and blue channels, illustrated in FIGS. 6A, 6B and 6C. The relationship occurs, for example, based at least in part on the use of the common relative luminance Y scale in each of the graphs of FIGS. 5-6C. For example, the darkest and the lightest gray patches from the gray targets j1, j2 and j3 can be selected as the black point and the white point for the scanner of interest, i.e., scanner 24. The luminance values for these two patches may be denoted as Y_{black} and Y_{white} where Y_{black}≧0 and Y_{white}≦100.

At step S106, the N-bit per channel data is quantized to M-bit per channel data according to the human visual response illustrated in FIG. 5. During quantization, the 2^{M}−2 uniform intervals of human visual response assigned to the y-axis of FIG. 5 are mapped into 2^{M}−2 non-uniform intervals of the scanner response representation with respect to the y-axis of FIGS. 6A, 6B and 6C. As such, a larger range of M-bit values along the y-axis will be allocated to regions of luminance along the x-axis that are more sensitive to change with respect to the human visual perception, and a smaller range of M-bit values along the y-axis will be allocated to regions of luminance along the x-axis that are less sensitive to change with respect to the human visual perception. For example, as can be observed from FIG. 5, the sensitivity to change is greatest where the slope of the curve is greatest, and sensitivity to change is less where the slope of the curve is less. Thus, with respect to the curve of FIG. 5 in relation to FIGS. 6A, 6B and 6C, for example, a greater range of M-bit values will be allocated for luminance values between 0 and 10 than will be allocated between 10 and 20. Likewise, a greater range of M-bit values will be allocated for luminance values between 10 and 20 than will be allocated between 20 and 30, and so on.

More particularly, in the present embodiment, the human visual response, i.e., [ƒ_{Res}(Y_{black}) ƒ_{Res}(Y_{white})], is divided into 2^{M}−2 equally spaced intervals along the y-axis represented in FIG. 5. The length of the interval is calculated as:

$$Δ {f}_{Re s} = \frac{{f}_{Re s} ( {Y}_{white} ) - {f}_{Re s} ( {Y}_{black} )}{{2}^{M} - 2} . \qquad Equation ( 2 )$$

Then, the i^{th} interval is given by [ƒ_{Res}(Yᵢ₋₁) ƒ_{Res}(Yᵢ)) where ƒ_{Res}(Yᵢ)=ƒ_{Res}(Y_{black})+i·Δƒ_{Res} and i={1, . . . 2^{M}−2}

Luminance Yᵢ is then computed for i∈{1, . . . 2^{M}−2} as follows:
Yᵢ=ƒ_{Res}⁻¹(ƒ_{Res}(Y_{black})+i·Δƒ_{Res}) Equation (3).

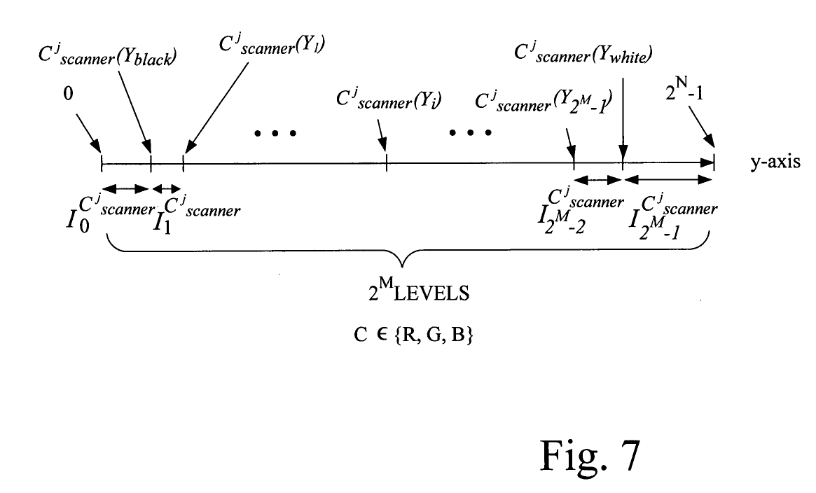

Next, each of the N-bit scanner R, G and B channels, i.e., y-axes for R_{scanner}, G_{scanner} and B_{scanner} of FIGS. 6A, 6B, and 6C, are partitioned into M-bit intervals as illustrated in FIG. 7. The partitions may be computed as follows:

R^{j}_{scanner}(Yᵢ), G^{j}_{scanner}(Yᵢ) and B^{j}_{scanner}(Yᵢ) for j∈{0, . . . K} and i ∈ {1, . . . 2^{M}−2}. In practice, this M-bit partition

$${{⋃}^{{2}^{M} - 1}}_{i = 0} {I}_{i}^{j}$$

varies with the gray target set j due to impure targets and metamerism in the scanner (see FIGS. 6A, 6B and 6C). To ensure that the quantization scheme is unique, it is desirable to have only one M-bit partitioning for each of the red, green and blue channels of the scanner.

The results may be implemented in the form of a lookup table (LUT) stored as a lookup table for receiving the N-bit per channel data and outputting the M-bit per channel data to produce perceptually uniform and neutral gray shades.

The scanner gray responses for the j^{th} set gray target are given by R^{j}_{scanner}(Y), G^{j}_{scanner}(Y) and B^{j}_{scanner}(Y) shown in FIGS. 6A, 6B and 6C. The values of these response functions may differ significantly from one another given a luminance value Y, which may be observed, for example, by comparing the red channel (see FIG. 6A), the green channel (see FIG. 6B) and the blue channel (see FIG. 6C) responses.

After quantization, the M-bit scanner RGB data for a gray target may have R, G and B values that differ significantly from one another. Large differences in the scanner R, G and B values often complicate the downstream color table building process. To ensure that the variation in the M-bit R, G and B values for gray patches is as small as possible, the scanner gray response functions may be mapped to the gamma corrected (gamma=2.0) standard RGB, sRGB gray response functions, where the R, G and B values are equal for gray targets.

A lookup table (LUT) that maps the two sets of gray response functions may be constructed using the steps in the example that follows, where M=8.

a) Partition [ƒ_{Res}(0) ƒ_{Res}(100)] into 2⁸ intervals.

The length of the interval is given by:

$$Δ {f}_{Re s}^{sRGB} = \frac{{f}_{Re s} ( 100 ) - {f}_{Re s} ( 0 )}{{2}^{8} - 1} \qquad Equation ( 4 )$$

Then, the p^{th} interval is given by └ƒ_{Res}(Yₚ₋₁) ƒ_{Res}(Yₚ)) where ƒ_{Res}(Yₚ)=ƒ_{Res}(0)+p·Δƒ_{Res}^{sRGB} and p∈{1, . . . 255}.

b) Compute Yₚ for p∈{1, . . . 254} as follows
Yₚ=ƒ_{Res}⁻¹(ƒ_{Res}(0)+p·66 ƒ_{Res}^{sRGB}) Equation (5)
Note that Y₀=0 and Y₂₅₅=100.

c) Calculate the sRGB values for Yₚ for p∈{1, . . . 254} using the following equation:

$${C}_{sRGB} ( {Y}_{p} ) = \{ \begin{matrix}255 \cdot [ 12.92 \cdot ( \frac{{Y}_{p}}{100} ) ] , & \frac{{Y}_{p}}{100} \leq 0.00304 \\ 255 \cdot [ 1.055 \cdot {( \frac{{Y}_{p}}{100} )}^{\frac{1}{2.0}} - 0.055 ] , & otherwise\end{matrix} \qquad Equation ( 6 )$$

where C∈{R, G, B}

d) The 8-bit gray preserving RGB output is given by linearly interpolating for the 8-bit R, G and B for a given set of N-bit scanner R, G and B values. If desired, any non-linear interpolation scheme can be used as long as it produces monotone increasing response functions as a function of luminance. An exemplary linear interpolation algorithm is set forth below.

$$\begin{matrix}{R}_{sRGB} ( Y ) = {R}_{sRGB} ( {Y}_{p} ) + \frac{( {R}_{Scanner}^{j} ( Y ) - {R}_{Scanner}^{j} ( {Y}_{p} ) ) \cdot {R}_{sRGB} ( {Y}_{p + 1} )}{{R}_{Scanner}^{j} ( {Y}_{p + 1} ) - {R}_{Scanner}^{j} ( {Y}_{p} )} if {R}_{Scanner}^{j} ( Y ) ∈ {I}_{p}^{Rj} \\ {G}_{sRGB} ( Y ) = {G}_{sRGB} ( {Y}_{p} ) + \frac{( {G}_{Scanner}^{j} ( Y ) - {G}_{Scanner}^{j} ( {Y}_{p} ) ) \cdot {G}_{sRGB} ( {Y}_{p + 1} )}{{G}_{Scanner}^{j} ( {Y}_{p + 1} ) - {G}_{Scanner}^{j} ( {Y}_{p} )} if {G}_{Scanner}^{j} ( Y ) ∈ {I}_{p}^{Gj} \\ {B}_{sRGB} ( Y ) = {B}_{sRGB} ( {Y}_{p} ) + \frac{( {B}_{Scanner}^{j} ( Y ) - {B}_{Scanner}^{j} ( {Y}_{p} ) ) \cdot {B}_{sRGB} ( {Y}_{p + 1} )}{{B}_{Scanner}^{j} ( {Y}_{p + 1} ) - {B}_{Scanner}^{j} ( {Y}_{p} )} if {B}_{Scanner}^{j} ( Y ) ∈ {I}_{p}^{Bj} .\end{matrix} \qquad Equations ( 7 )$$

, where p∈{0, . . . 255}. Here, R_{Scanner}^{j}(Y), G_{Scanner}^{j}(Y) and B_{Scanner}^{j}(Y) are the N-bit scanner RGB value for the j^{th} set gray target response functions.

This LUT is smooth if length(Iₚ^{C}^{_{scanner}}^{^{j}})≧length(Iₚ^{C}^{_{sRGB}}^{^{J}}) for all C∈{R, G, B}. This LUT maps the monotone increasing gray response functions of the scanner to the monotone increasing gray response functions in the gamma corrected sRGB color space.

Equation 7 also dictates that the LUT changes with the scanner gray response functions.

Since the gray response functions vary with the gray target set (e.g., each set of gray target produces a set of gray response functions, as shown in FIGS. 6A, 6B and 6C) and a unique LUT is desired, it is desirable to find a single set gray response functions that is representative of those corresponding to all the gray target sets, i.e., the monotonic function.

This representative gray response functions, denoted as R_{scanner}(Y), G_{scanner}(Y) and B_{scanner}(Y), can be obtained by solving the following constrained optimization problem:

$$[ {R}_{scanner} ( {Y}_{p} ) {G}_{scanner} ( {Y}_{p} ) {B}_{scanner} ( {Y}_{p} ) ] = argmin \{ var \{ {R}_{sRGB} ( {Y}_{p} ) , {G}_{sRGB} ( {Y}_{p} ) , {B}_{sRGB} ( {Y}_{p} ) \} \}$$

$$min ( {\{ {R}_{scanner}^{j} ( {Y}_{p} ) \}}_{j = 0}^{κ} ) \leq {R}_{scanner} ( {Y}_{p} ) \leq max ( {\{ {R}_{scanner}^{j} ( {Y}_{p} ) \}}_{j = 0}^{κ} )$$

$$min ( {\{ {G}_{scanner}^{j} ( {Y}_{p} ) \}}_{j = 0}^{κ} ) \leq {G}_{scanner} ( {Y}_{p} ) \leq max ( {\{ {G}_{scanner}^{j} ( {Y}_{p} ) \}}_{j = 0}^{κ} )$$

$$min ( {\{ {B}_{scanner}^{j} ( {Y}_{p} ) \}}_{j = 0}^{κ} ) \leq {B}_{scanner} ( {Y}_{p} ) \leq max ( {\{ {B}_{scanner}^{j} ( {Y}_{p} ) \}}_{j = 0}^{κ} )$$

subject to:
1)
R_{scanner}(Yₚ)−R_{scanner}(Yₚ₋₁)≧0,
G_{scanner}(Yₚ)−G_{scanner}(Yₚ₋₁)≧0,
B_{scanner}(Yₚ)−B_{scanner}(Yₚ₋₁)≧0,
2)
length(Iₚ^{R}^{_{scanner}})≧length(Iₚ^{R}^{_{sRGB}})
length(Iₚ^{G}^{_{scanner}})≧length(Iₚ^{G}^{_{sRGB}})
length(Iₚ^{B}^{_{scanner}})≧length(Iₚ^{B}^{_{sRGB}})
for p=1, . . . 255.
   Here, var denotes the variance.

The first constraint in the above restricts the solution to the class of monotone increasing functions whereas the second constraint ensures that the LUT has smooth transition.

The resulting LUT quantizes the N-bit (per channel) raw data to 8-bit (per channel) data according to the human visual system sensitivity while minimizing the variation in the R, G and B values for gray targets. This quantization scheme results in very efficient M-bit, e.g., 8-bit representation of the N-bit data throughout the entire luminance range. This 8-bit representation maximizes the shade distinction along the luminance channel and the neutrality of responses to gray targets. The same conclusion applies for any M<N. Moreover, the white and black points can be adjusted according to the needs of the color table building process downstream.

This exemplary method of an embodiment of the present invention may be fully automated to produce an optimal LUT for the scanner offline without any manual tweak.

In the embodiment discussed above, bit depth reduction is performed efficiently, while reducing the impact of bit reduction on the perceived quality of the reproduced image by maximizing the ability to visually discriminate gray shades while preserving their neutrality. In turn, this embodiment of the present invention strives to produce perceptually uniform and neutral gray shades.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of bit depth reduction for an apparatus, comprising:
establishing a human visual response versus relative luminance, said human visual response being defined by 2^{M} levels;
determining a scanner response versus said relative luminance for at least one channel of scanner data, said scanner response being represented by N-bit per channel data, wherein N is greater than M;
relating said human visual response to said scanner response; and
quantizing said N-bit per channel data to M-bit per channel data according to said human visual response.

2. The method of claim 1, wherein said N-bit per channel data is represented non-uniformly by said M-bit per channel data.

3. The method of claim 1, wherein during the act of quantizing said scanner response represented by said N-bit per channel data is partitioned into 2^{M}−2 non-uniform intervals represented by 2^{M} digital levels.

4. The method of claim 3, wherein said non-uniform intervals are determined to produce perceptually uniform and neutral gray shades.

5. The method of claim 1, wherein the results said method are stored as a lookup table for receiving said N-bit per channel data and outputting said M-bit per channel data to produce perceptually uniform and neutral gray shades.

6. The method of claim 1, wherein said N-bit per channel data is RGB 16-bit per channel data and said M-bit per channel data is RGB 8-bit per channel data.

7. An imaging system, comprising:
a scanner; and
a processor communicatively coupled to said scanner, said processor executing program instruction to perform bit depth reduction by the acts of:
establishing a human visual response versus relative luminance, said human visual response being defined by 2^{M} levels;
determining a scanner response versus said relative luminance for at least one channel of scanner data, said scanner response being represented by N-bit per channel data, wherein N is greater than M;
relating said human visual response to said scanner response; and
quantizing said N-bit per channel data to M-bit per channel data according to said human visual response.

8. The imaging system of claim 7, wherein said N-bit per channel data is represented non-uniformly by said M-bit per channel data.

9. The imaging system of claim 7, wherein during the act of quantizing said scanner response represented by said N-bit per channel data is partitioned into 2^{M}−2 non-uniform intervals represented by 2^{M} digital levels.

10. The imaging system of claim 9, wherein said non-uniform intervals are determined to produce perceptually uniform and neutral gray shades.

11. The imaging system of claim 7, wherein the results said method are stored as a lookup table for receiving said N-bit per channel data and outputting said M-bit per channel data to produce perceptually uniform and neutral gray shades.

12. The imaging system of claim 7, wherein said N-bit per channel data is RGB 16-bit per channel data and said M-bit per channel data is RGB 8-bit per channel data.

13. The imaging system of claim 7, wherein said processor is included in at least one of a host and a controller of an imaging apparatus.

14. The imaging system of claim 7, wherein said program instructions are implemented in an imaging driver.

15. The imaging system of claim 7, wherein said program instructions are implemented in at least one of software, hardware, and firmware.
